(19) United States
(12) Patent Application Publication
(10) Pub. No.: US 2024/0241793 A1
(43) Pub. Date: Jul. 18, 2024

(54) HOST ASSISTED LINK START

(71) Applicant: Micron Technology, Inc., Boise, ID (US)

(72) Inventor: Stephen Hanna, Fort Collins, CO (US)

(21) Appl. No.: 18/535,553

(22) Filed: Dec. 11, 2023

Related U.S. Application Data
(60) Provisional application No. 63/480,406, filed on Jan. 18, 2023.

(51) Int. Cl. G06F 11/14; G06F 1/28

(52) U.S. Cl. CPC G06F 11/142; G06F 1/28

(57) ABSTRACT

Methods, systems, and devices for host assisted link start are described. A memory device may receive, from a host device, a first request message for a recovery configuration associated with power recovery of a peripheral of the memory device. The memory device may transmit, to the host device based at least in part on the first request message, a first response message including the recovery configuration associated with the power recovery of the peripheral of the memory device. The recovery configuration may include parametric data associated with the peripheral of the memory device to store at the host device.

### CROSS REFERENCE

The present Application for Patent claims the benefit of U.S. Provisional Patent Application No. 63/480,406 by HANNA et al., entitled “HOST ASSISTED LINK START,” filed Jan. 18, 2023, assigned to the assignee hereof, and expressly incorporated by reference herein.

### FIELD OF TECHNOLOGY

The following relates to one or more systems for memory, including host assisted link start.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports host assisted link start in accordance with examples as disclosed herein.

FIG. 2 illustrates an example of a system that supports host assisted link start in accordance with examples as disclosed herein.

FIG. 3 illustrates an example of a power-down configuration that supports host assisted link start in accordance with examples as disclosed herein.

FIG. 4 illustrates an example of a power-up configuration that supports host assisted link start in accordance with examples as disclosed herein.

FIG. 5 shows a block diagram of a memory device that supports host assisted link start in accordance with examples as disclosed herein.

FIG. 6 shows a block diagram of a host device that supports host assisted link start in accordance with examples as disclosed herein.

FIGS. 7 through 10 show flowcharts illustrating a method or methods that support host assisted link start in accordance with examples as disclosed herein.

### DETAILED DESCRIPTION

A memory system may include a memory device. In some cases, the memory system may decrease power consumption by managing a power mode for the memory device. For example, the memory system may switch the memory device from operating in a first power mode to a lower power mode. Examples of a lower power mode may include, but are not limited to, a sleep mode or a deep-sleep mode. Although operating the memory device in the lower power mode may decrease power consumption, the memory system may experience unwanted latency in returning the memory device to operate in the first (e.g., higher) power mode (e.g., in response to switching the memory device back to the first power mode from the lower power mode). Therefore, it may be desirable to reduce the power consumption for the memory device without switching the memory device to the low power mode in some circumstances.

The present disclosure relates to techniques for powering-down a component, such as a peripheral, of a memory device or a host device, for example, a Universal Flash Storage (UFS) device, for power saving. The peripheral of the memory device or the host device may be an input/output (I/O) device, among other examples. The memory device or the host device may provide a recovery configuration associated with power recovery of the peripheral. In some examples, the recovery configuration can be stored at the host device, for example, a UFS host device. The recovery configuration may include parametric data (e.g., serializer/deserializer (SerDes) data, media trim data) associated with the peripheral of the memory device, among other information. Additionally, to reduce the power consumption for the memory device or the host device, the present disclosure relates to techniques for powering-up the peripheral of the memory device or the host device. For example, the host device may provide the recovery configuration (e.g., stored recovery configuration) associated with the power recovery of the peripheral to the memory device. The memory device may perform one or more operations to return the peripheral of the memory device to operation using the recovery configuration associated with the peripheral and received from the host device.

By storing the recovery configuration including parametric data associated with the peripheral of the memory device at the host device, and providing by the host device the recovery configuration to the memory device in response to restoring operations of the peripheral of the memory device, the memory device may experience power savings and reduced latency in response to restoring normal operations, among other benefits.

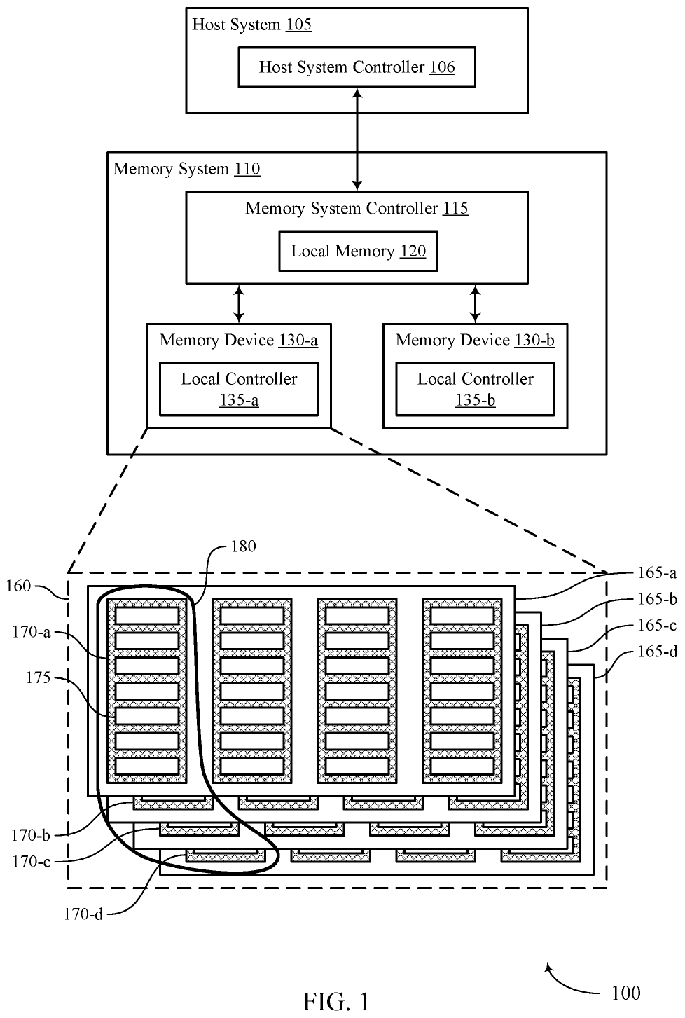

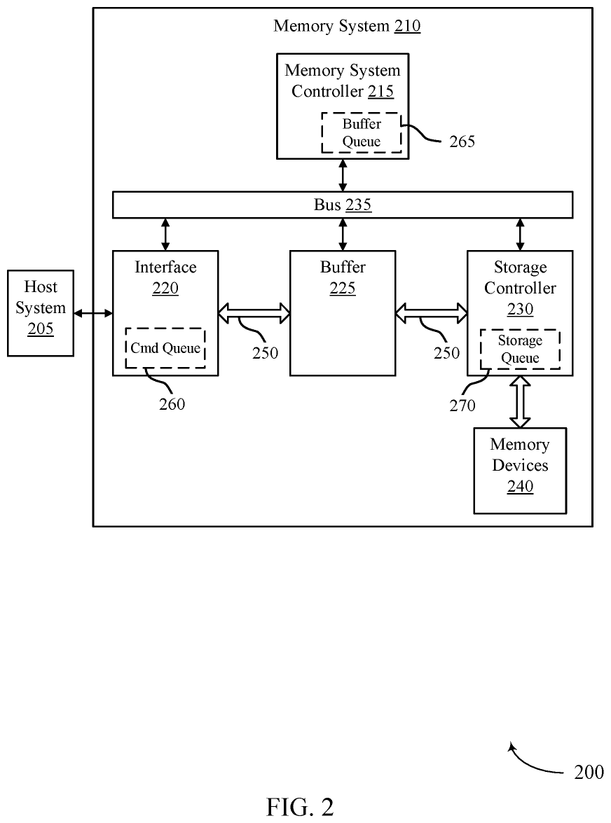

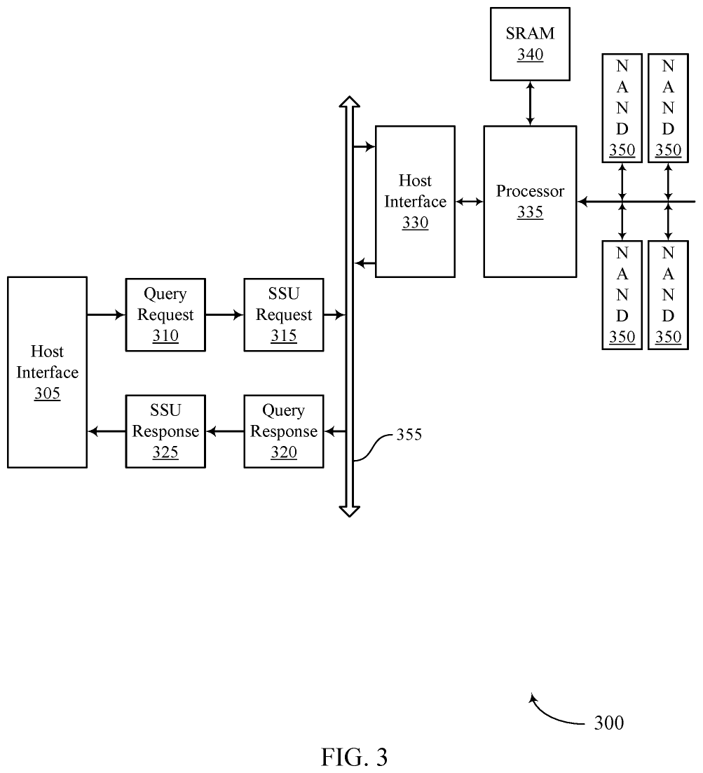

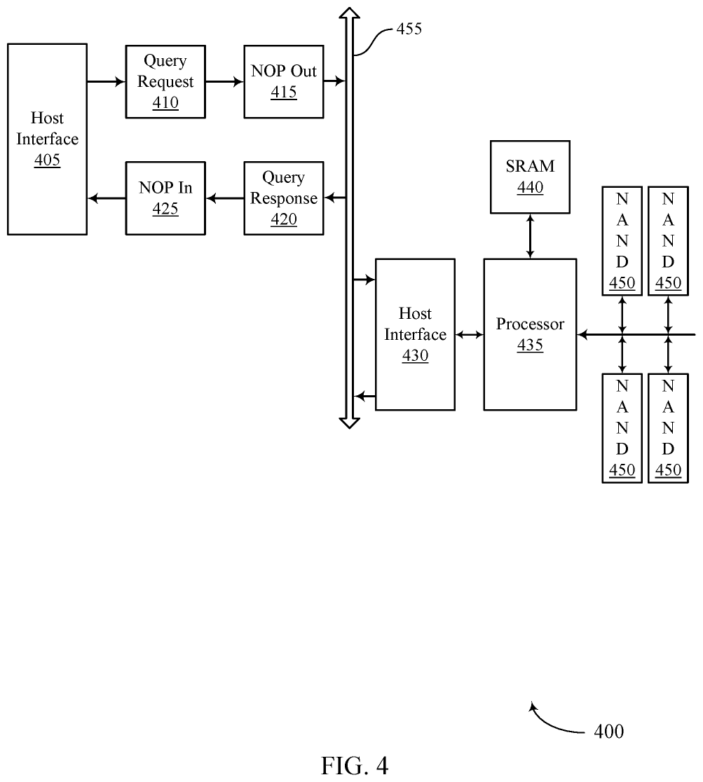

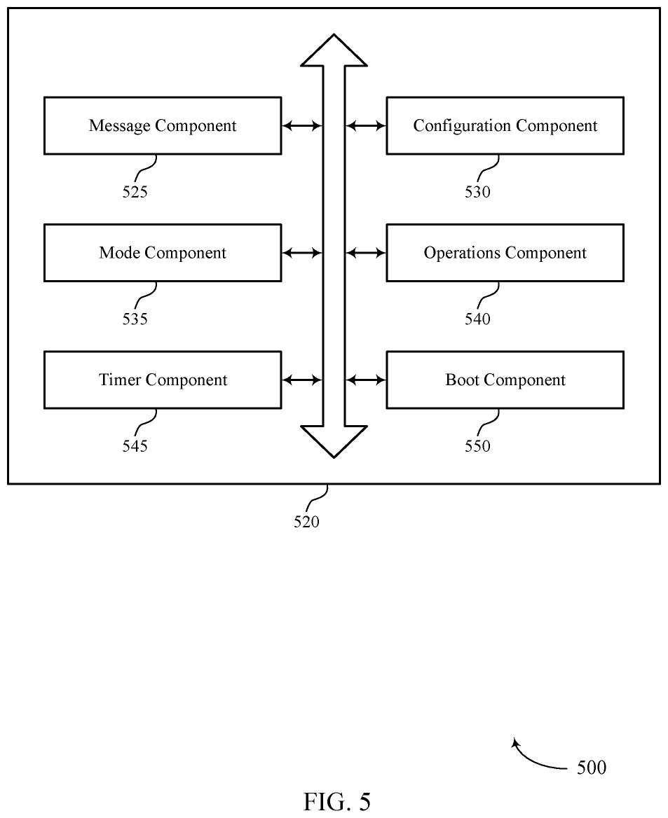

Features of the disclosure are initially described in the context of systems with reference to FIGS. 1 and 2. Features of the disclosure are described in the context of configurations with reference to FIGS. 3 and 4. These and other features of the disclosure are further illustrated by and described in the context of device diagram and flowcharts that relate to host assisted link start with reference to FIGS. 5 through 10.

FIG. 1 illustrates an example of a system 100 that supports host assisted link start in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a UFS device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include ROM or other memory that may store operating code (e.g., executable instructions) executable by the memory system controller 115 to perform functions ascribed herein to the memory system controller 115. In some cases, the local memory 120 may additionally, or alternatively, include SRAM or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support host assisted link start. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

One aspect of the present disclosure relates to enabling the host system 105 and the memory system 110 to support signaling related to techniques for powering-down, for example, a peripheral associated with the memory system 110. The host system 105 (e.g., a host device) may transmit, a first request message for a recovery configuration associated with power recovery of a peripheral of the memory system 110 (e.g., a memory device 130). The memory system 110 (e.g., the memory device 130) may receive the first request message for the recovery configuration associated with the power recovery of, for example, the peripheral of the memory system 110 (e.g., the memory device 130). Based at least in part on (e.g., based on, in response to) receiving the first request message, the memory system 110 (e.g., the memory device 130) may transmit, and the host system 105 may receive, a first response message including the recovery configuration associated with the power recovery of, for example, the peripheral of the memory system 110 (e.g., the memory device 130). The recovery configuration may include, among other information, parametric data associated with the peripheral of the memory system 110 (e.g., the memory device 130) for storing at the host system 105. The memory system 110 (e.g., the memory device 130) may operate the peripheral of the memory system 110 (e.g., the memory device 130) in a power mode of a set of power modes. The power mode may be different than a lower power mode, the lower power mode such as a sleep mode or a deep-sleep mode associated with the memory system 110 (e.g., the memory device 130). For example, the power mode may correspond to entirely removing power from the peripheral of the memory system 110 (e.g., the memory device 130) in some examples.

Another aspect of the present disclosure relates to enabling the host system 105 and the memory system 110 to support signaling related to techniques for powering-up a peripheral associated with the memory system 110. The host system 105 (e.g., a host device) may transmit, and the memory system 110 (e.g., the memory device 130) may receive, a first request message including a recovery configuration associated with a peripheral of the memory system 110 (e.g., the memory device 130). The recovery configuration may include, among other information, parametric data associated with the peripheral of the memory system 110 (e.g., the memory device 130). Based at least in part on (e.g., based on, in response to) receiving the first request message, the memory system 110 (e.g., the memory device 130) may transmit, and the host system 105 may receive, a first response message. The memory system 110 (e.g., the memory device 130) may reconfigure the peripheral of the memory system 110 (e.g., the memory device 130) based at least in part on the recovery configuration including the parametric data associated with the peripheral of the memory system 110 (e.g., the memory device 130). The memory system 110 (e.g., the memory device 130) may operate the peripheral of the memory system 110 (e.g., the memory device 130) in a lower power mode based at least in part on (e.g., based on, in response to) the reconfiguring.

Accordingly, the system 100 may provide power saving to the memory system 110 by storing recovery configuration including parametric data associated with the peripheral of the memory system 110 (e.g., the memory device 130) at the host system 105 and providing by the host system 105 the recovery configuration to the memory system 110 in response to restoring operations of peripheral of the memory system 110 (e.g., the memory device 130). For example, by providing by the host system 105 the recovery configuration to the memory system 110 may reduce a latency associated with restoring operations of the peripheral of the memory system 110 (e.g., the memory device 130), among other advantages.

FIG. 2 illustrates an example of a system 200 that supports host assisted link start in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) in response to the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

Once the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

The host system 205 and the memory system 210 may support signaling related to techniques for powering-down a peripheral associated with the memory system 210. The host system 205 (e.g., a host device) may transmit, a first request message for a recovery configuration associated with power recovery of a peripheral of the memory system 210 (e.g., a memory device 240). The memory system 210 (e.g., the memory device 240) may receive the first request message for the recovery configuration associated with the power recovery of the peripheral of the memory system 210 (e.g., the memory device 240). Based at least in part on (e.g., based on, in response to) receiving the first request message, the memory system 210 (e.g., the memory device 240) may transmit, and the host system 205 may receive, a first response message including the recovery configuration associated with the power recovery of the peripheral of the memory system 210 (e.g., the memory device 240).

The recovery configuration may include parametric data associated with the peripheral of the memory system 210 (e.g., the memory device 240) for storing at the host system 205. The memory system 210 (e.g., the memory device 240) may operate the peripheral of the memory system 210 (e.g., the memory device 240) in a power mode of a set of power modes. The power mode may be different than a low power mode, such as a sleep mode or a deep-sleep mode associated with the memory system 210 (e.g., the memory device 240). For example, the power mode may correspond to entirely removing power from the peripheral of the memory system 210 (e.g., the memory device 240).

Additionally, or alternatively, the host system 205 and the memory system 210 may support signaling related to techniques for powering-up a peripheral associated with the memory system 210. The host system 205 may transmit, and the memory system 210 (e.g., the memory device 240) may receive, a first request message including a recovery configuration associated with a peripheral of the memory system 210 (e.g., the memory device 240). The recovery configuration may include parametric data associated with the peripheral of the memory system 210 (e.g., the memory device 240). Based at least in part on (e.g., based on, in response to) receiving the first request message, the memory system 210 (e.g., the memory device 240) may transmit, and the host system 205 may receive, a first response message. The memory system 210 (e.g., the memory device 240) may reconfigure the peripheral of the memory system 210 (e.g., the memory device 240) based at least in part on the recovery configuration including the parametric data associated with the peripheral of the memory system 210 (e.g., the memory device 240). The memory system 210 (e.g., the memory device 240) may operate the peripheral of the memory system 210 (e.g., the memory device 240) in a power mode based at least in part on (e.g., based on, in response to) the reconfiguring.

Accordingly, the system 200 may provide power saving to the memory system 210 by storing recovery configuration including parametric data associated with the peripheral of the memory system 210 (e.g., the memory device 240) at the host system 205 and providing by the host system 205 the recovery configuration to the memory system 210 in response to restoring operations of peripheral of the memory system 210 (e.g., the memory device 240). For example, by providing by the host system 205 the recovery configuration to the memory system 210 may decrease a latency associated with restoring operations of the peripheral of the memory system 210 (e.g., the memory device 240).

FIG. 3 illustrates an example of a power-down configuration 300 that supports host assisted link start in accordance with examples as disclosed herein. The power-down configuration 300 may be implemented by a memory system and a host system, which may be an example of a memory system and a host system as described with reference to FIGS. 1 and 2. The memory system and the host system including various components thereof may support one or more protocols, including one or more physical layer protocols, such as M-PHY physical layer. The power-down configuration 300 may be implemented by a memory system and a host system to exchange messaging (e.g., control information, data, commands, instructions, and the like), using one or more protocols, that promotes power saving at the memory system.

In the example of FIG. 3, the exchange of signaling (e.g., control information, data, commands, instructions, and the like) may be associated with various components, such as a host interface 305, a host interface 330, a bus 355 or other connection facilitating communication, a processor 335 (e.g., a central processor unit (CPU)), an SRAM 340, and one or more NAND 350 memory devices. Each of these components may communicate, directly or indirectly, with one another (e.g., via one or more buses). In the following description of the power-down configuration 300, some aspects may also be omitted from the power-down configuration 300, and other aspects may be added to the power-down configuration 300.

A host device may initiate a low power phase (e.g., a low power cycle) for a peripheral of a memory device. For example, the host device via the host interface 305, may transmit a request message to the memory device. The request message may indicate timing information for switching the peripheral of the memory device to a respective power mode of a set of power modes (e.g., low power mode, sleep mode, deep sleep mode, pre-power down mode, no power mode, and the like). The request message may be, for example, a Start-Stop-Unit (SSU) request Universal Flash Storage (UFS) Protocol Information Unit (UPIU) 315. The SSU request UPIU 315 may include a UPIU header information and additional information indicating a power down command from the host device. In some other implementations, the host device may initiate a low power phase (e.g., a low power cycle) for a peripheral of the host device.

In some examples, the timing information may indicate that the memory device has n hours, where n is a positive integer, to switch to operating the peripheral of the memory device at the respective power mode. For example, the timing information may indicate that the memory device has 3 hours to transition operating the peripheral of the memory device from a normal power mode to a pre-power down mode. In some examples, the memory device may enable a timer based at least in part on the timing information. For example, the memory device may activate the timer and, based at least in part on (e.g., based on, in response to) the timer lapsing (e.g., expiring), the memory device may switch the peripheral of the memory device from a normal power mode to a pre-power down mode.

Additionally, or alternatively, the memory device may process one or more operations associated with the peripheral of the memory device based at least in part on (e.g., based on, in response to) the request message, for example, the SSU request UPIU 315. In some examples, in response to the memory device completing the one or more operations, the memory device may switch to operating the peripheral of the memory device at the respective power mode. Put another way, in response to the memory device having completed any one or more pending operations, the memory device may transition the peripheral of the memory device to the pre-power down mode.

The memory device may transmit, and the host device may receive, a response message based at least in part on (e.g., based on, in response to) switching the peripheral of the memory device to the pre-power down mode. The response message may additionally indicate (e.g., acknowledge) that the peripheral of the memory device is operating in the respective power mode (e.g., the pre-power down mode). The response message may be, for example, an SSU response UPIU 325. As such, the memory device may indicate to the host device in response to the memory device is ready to power off the peripheral of the memory device without risk of losing information (e.g., data).

As described herein, to support power saving at the memory device while reducing latency at the memory device in response to restoring normal operations, the memory device may exchange information associated with the peripheral of the memory device with the host device. The host device may transmit, and the memory device may receive, a request message for a recovery configuration associated with power recovery of the peripheral of the memory device. The request message may be, for example, a Query Request 310 including a “Read Descriptor Opcode”. The Query Request 310 including the Read Descriptor Opcode may be for the recovery configuration associated with power recovery of the peripheral of the memory device. The Read Descriptor Opcode may be a fixed or variable length.

In the present disclosure, one or more fields associated with the Read Descriptor Opcode may be defined to support the power recovery of the peripheral of the memory device. In some examples, a Descriptor IDN field associated with the Read Descriptor Opcode may be defined to support the power recovery of the peripheral of the memory device. The Descriptor IDN field may include a value that indicates a type of Descriptor to retrieve from the memory device. In the example of FIG. 3, the type of Descriptor may be a Recovery Descriptor associated with the power recovery of the peripheral of the memory device. In some examples, an Index field associated with the Read Descriptor Opcode may be defined to support the power recovery of the peripheral of the memory device. An index value of the Index field may identify a type of Descriptor. In the example of FIG. 3, the index value of the Index field may identify a Recovery Descriptor associated with the power recovery of the peripheral of the memory device. In some examples, a Selector field associated with the Read Descriptor Opcode may be defined to support the power recovery of the peripheral of the memory device. The Selector field may identify a Recovery Descriptor associated with the power recovery of the peripheral of the memory device.

Additionally, or alternatively, the Read Descriptor Opcode may include one or more parameters, such as a M-TX Termination ATE Calibration parameter, an M-TX LDO ARE calibration parameter, an M-RX termination parameter, an M-RX analog front-end (AFE) offset AFE calibration parameter, an M-RX LDO ATE calibration parameter, an MCC low drop-out regulator (LDO) calibration parameter, or an MCC VCO ATE calibration parameter, among other examples.

The memory device may generate a recovery configuration based at least in part on the received request message, such as the received Query Request 310 including the “Read Descriptor Opcode”. For example, the memory device may construct a Recovery Descriptor associated with the power recovery of the peripheral of the memory device based at least in part on the received Query Request 310 including the “Read Descriptor Opcode”. The recovery configuration may include parametric data associated with the peripheral of the memory device, for storing at the host device, based at least in part on the received Query Request 310 including the “Read Descriptor Opcode”. The memory device may transmit, and the host device may receive, a response message, after generating the recovery configuration associated with the power recovery of the peripheral of the memory device. The response message may be, for example, a Query Response 320 including the construed Recovery Descriptor. Based at least in part on the received Query Response 320 including the construed Recovery Descriptor, the host device may remove power from the peripheral of the memory device.

By storing the recovery configuration including parametric data associated with the peripheral of the memory device at the host device may provide power saving and reduced latency in response to restoring normal operations (e.g., including re-establishing a link between the memory device and the host device) at the memory device for the peripheral of the memory device.

FIG. 4 illustrates an example of a power-up configuration 400 that supports host assisted link start in accordance with examples as disclosed herein. The power-up configuration 400 may be implemented by a memory system and a host system, which may be an example of a memory system and a host system as described with reference to FIGS. 1 and 2. The memory system and the host system including various components thereof may support one or more protocols, including one or more physical layer protocols, such as M-PHY physical layer. The power-up configuration 400 may be implemented by a memory system and a host system to exchange messaging, using one or more protocols, that promotes power saving at the memory system. In the example of FIG. 4, the exchange of signaling (e.g., control information, data, commands, instructions, and the like) may be associated with various components, such as a host interface 405, a host interface 430, a bus 455 or other connection facilitating communication, a processor 435 (e.g., a CPU), a SRAM 440, and one or more NAND 450 memory devices. Each of these components may communicate, directly or indirectly, with one another (e.g., via one or more buses). In the following description of the power-up configuration 400, some aspects may also be omitted from the power-up configuration 400, and other aspects may be added to the power-up configuration 400.

In the example of FIG. 4, a host device may return power to a memory device. For example, the host device may return power to a peripheral of the memory device. The memory device may perform a boot operation for a power recovery of the peripheral of the memory device. At the memory device and the host device initialization begins of an M-PHY layer, which results in a PWM-G1 speed gear. In some examples, the boot operation may include initializing a connection path between the peripheral of the memory device and the host device. In some examples, based at least in part on (e.g., based on, in response to) the boot operation (e.g., boot sequence), the memory device and the host device may exchange one or more messages. In some other implementations, the host device may return power to a peripheral of the host device.

For example, the host device may transmit, and the memory device may receive, a first ping message over the connection path between the peripheral of the memory device and the host device. The first ping message may be, for example, an NOP OUT UPIU 415. The transmission and reception of the NOP OUT UPIU 415 may be for verifying the connection path between the peripheral of the memory device and the host device. In response to the received first ping message, the memory device may transmit, and the host device may receive, a second ping message over the connection path between the peripheral of the memory device and the host device. The second ping message may be, for example, an NOP IN UPIU 425. The transmission and reception of the NOP IN UPIU 425 may be for verifying the connection path between the peripheral of the memory device and the host device.

Additionally, or alternatively, the host device may transmit, and the memory device may receive, a request message. The request message may be, for example, a Query Request 410 including a “Write Descriptor Opcode”. The Query Request 410 including the Write Descriptor Opcode may be for the recovery configuration associated with power recovery of the peripheral of the memory device. In the present disclosure, one or more fields associated with the Write Descriptor Opcode may be defined to support the power recovery of the peripheral of the memory device. In some examples, a Descriptor IDN field associated with the Write Descriptor Opcode may be defined to support the power recovery of the peripheral of the memory device. The Descriptor IDN field may include a value that indicates a type of Descriptor to retrieve from the memory device. In the example of FIG. 4, the type of Descriptor may be a Recovery Descriptor associated with the power recovery of the peripheral of the memory device. In some examples, an Index field associated with the Write Descriptor Opcode may be defined to support the power recovery of the peripheral of the memory device. An index value of the Index field may identify a type of Descriptor. In the example of FIG. 4, the index value of the Index field may identify a Recovery Descriptor associated with the power recovery of the peripheral of the memory device. In some examples, a Selector field associated with the Write Descriptor Opcode may be defined to support the power recovery of the peripheral of the memory device. The Selector field may identify a Recovery Descriptor associated with the power recovery of the peripheral of the memory device.

The memory device may decode the one or more fields associated with the Write Descriptor Opcode and access the Recovery Descriptor associated with the power recovery of the peripheral of the memory device, and reconfigure the peripheral of the memory device based at least in part on the recovery configuration associated with the Recovery Descriptor to restore normal operations for the peripheral of the memory device. Put another way, the host device may provide, to the memory device, the stored recovery configuration to restore normal operations for the peripheral of the memory device. The memory device may transmit, and the host device may receive, a response message in response to reconfiguring the peripheral of the memory device based at least in part on the recovery configuration associated with the Recovery Descriptor. The response message may be, for example, a Query Response 420. After re-establishing a link between the memory device and the host device based at least in part on the Query Request 410, the Query Response 420, or both, the memory device and the host device may be synchronized and the boot operation may be completed.

By providing stored recovery configuration including parametric data associated with the peripheral of the memory device to the memory device may provide power saving and reduced latency in response to restoring normal operations (e.g., including re-establishing a link between the memory device and the host device) at the memory device for the peripheral of the memory device.

FIG. 5 shows a block diagram 500 of a memory device 520 that supports host assisted link start in accordance with examples as disclosed herein. The memory device 520 may be an example of aspects of a memory device as described with reference to FIGS. 1 through 4. The memory device 520, or various components thereof, may be an example of means for performing various aspects of host assisted link start as described herein. For example, the memory device 520 may include a message component 525, a configuration component 530, a mode component 535, an operations component 540, a timer component 545, a boot component 550, or any combination thereof. Each of these components may communicate, directly or indirectly, with one another (e.g., via one or more buses).

The message component 525 may be configured as or otherwise support a means for receiving, at the memory device 520 from a host device, a first request message for a recovery configuration associated with power recovery of a peripheral of the memory device 520. In some examples, the message component 525 may be configured as or otherwise support a means for transmitting, to the host device based at least in part on receiving the first request message, a first response message including the recovery configuration associated with the power recovery of the peripheral of the memory device 520, the recovery configuration including parametric data associated with the peripheral of the memory device 520 for storing at the host device.

In some examples, the mode component 535 may be configured as or otherwise support a means for operating the peripheral of the memory device 520 in a power mode of a set of power modes based at least in part on receiving the first request message, or transmitting the first response message, or a combination thereof.

In some examples, the message component 525 may be configured as or otherwise support a means for receiving, from the host device, a second request message for operating the peripheral of the memory device 520 in a power mode, the second request message indicating timing information for switching the peripheral of the memory device to the power mode, and the second request message including a Start-Stop-Unit (SSU) request Universal Flash Storage (UFS) Protocol Information Unit (UPIU). In some examples, the message component 525 may be configured as or otherwise support a means for receiving the first request message, or transmitting the first response message, or a combination thereof, based at least in part on receiving the second request message.

In some examples, the operations component 540 may be configured as or otherwise support a means for processing one or more operations associated with the peripheral of the memory device 520 based at least in part on receiving the second request message. In some examples, the mode component 535 may be configured as or otherwise support a means for operating the peripheral of the memory device 520 in the power mode based at least in part on processing the one or more operations associated with the peripheral of the memory device 520. In some examples, the message component 525 may be configured as or otherwise support a means for receiving the first request message, or transmitting the first response message, or a combination thereof, based at least in part on operating the peripheral of the memory device 520 in the power mode.

In some examples, the message component 525 may be configured as or otherwise support a means for transmitting, to the host device, a second response message based at least in part on receiving the second request message and processing the one or more operations associated with the peripheral of the memory device 520, the second response message indicating that the peripheral of the memory device 520 is operating in the power mode, and the second response message including an SSU response UPIU. In some examples, the message component 525 may be configured as or otherwise support a means for receiving the first request message, or transmitting the first response message, or a combination thereof, based at least in part on transmitting the second response message.

In some examples, the timer component 545 may be configured as or otherwise support a means for enabling a timer based at least in part on the timing information. In some examples, the mode component 535 may be configured as or otherwise support a means for operating the peripheral of the memory device 520 in the power mode based at least in part on an expiration of the timer.

In some examples, the configuration component 530 may be configured as or otherwise support a means for generating the recovery configuration including the parametric data associated with the peripheral of the memory device 520 based at least in part on receiving the first request message. In some examples, the message component 525 may be configured as or otherwise support a means for transmitting the first response message based at least in part on generating the recovery configuration including the parametric data associated with the peripheral of the memory device 520.

In some examples, the message component 525 may be configured as or otherwise support a means for receiving, from the host device, a second request message including the recovery configuration associated with power recovery of the peripheral of the memory device 520. In some examples, the mode component 535 may be configured as or otherwise support a means for operating the peripheral of the memory device 520 in a first power mode by switching to the first power mode from a second power mode based at least in part on receiving the second request message.

In some examples, the configuration component 530 may be configured as or otherwise support a means for reconfiguring the peripheral of the memory device 520 based at least in part on receiving the second request message including the recovery configuration including the parametric data associated with the peripheral of the memory device 520 and switching to the first power mode from the second power mode.

In some examples, the message component 525 may be configured as or otherwise support a means for transmitting, to the host device, a second response message including an acknowledgment based at least in part on receiving the second request message. In some examples, the mode component 535 may be configured as or otherwise support a means for operating the peripheral of the memory device 520 in the first power mode by switching to the first power mode from the second power mode based at least in part on transmitting the second response message.

In some examples, the boot component 550 may be configured as or otherwise support a means for performing a boot operation for the power recovery of the peripheral of the memory device 520 based at least in part on receiving the second request message, or transmitting the second response message, or a combination thereof. In some examples, the boot operation includes initializing a connection path between the peripheral of the memory device 520 and the host device.

In some examples, the message component 525 may be configured as or otherwise support a means for receiving, from the host device, a first ping message over the connection path between the peripheral of the memory device 520 and the host device. In some examples, the message component 525 may be configured as or otherwise support a means for transmitting, to the host device, a second ping message over the connection path between the peripheral of the memory device 520 and the host device and based at least in part on receiving the first ping message.

In some examples, the recovery configuration including the parametric data is associated with a physical layer of the peripheral of the memory device 520, or a physical layer of the peripheral of the host device, or a combination thereof. In some examples, the peripheral of the memory device 520 includes a peripheral memory associated with one or more I/O devices.

In some examples, the message component 525 may be configured as or otherwise support a means for receiving, from a host device at the memory device 520, a first request message including a recovery configuration associated with a peripheral of the memory device 520 for power recovery of the peripheral of the memory device 520, the recovery configuration including the parametric data associated with the peripheral of the memory device 520. In some examples, the message component 525 may be configured as or otherwise support a means for transmitting, to the host device, a first response message based at least in part on receiving, from the host device, the first request message. The configuration component 530 may be configured as or otherwise support a means for reconfiguring the peripheral of the memory device 520 based at least in part on the recovery configuration including the parametric data associated with the peripheral of the memory device 50. The mode component 535 may be configured as or otherwise support a means for operating the peripheral of the memory device 520 in a power mode based at least in part on receiving the first request message, or transmitting the first response message, or a combination thereof. In some examples, the recovery configuration including the parametric data associated with the peripheral of the memory device 520 is stored at the host device.

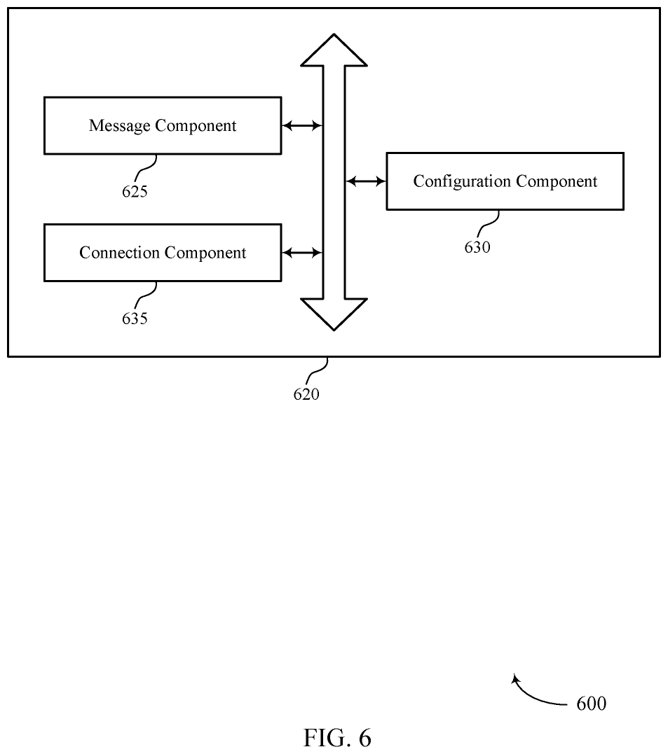

FIG. 6 shows a block diagram 600 of a host device 620 that supports host assisted link start in accordance with examples as disclosed herein. The host device 620 may be an example of aspects of a host device as described with reference to FIGS. 1 through 4. The host device 620, or various components thereof, may be an example of means for performing various aspects of host assisted link start as described herein. For example, the host device 620 may include a message component 625, a configuration component 630, a connection component 635, or any combination thereof. Each of these components may communicate, directly or indirectly, with one another (e.g., via one or more buses).

The message component 625 may be configured as or otherwise support a means for transmitting, from the host device 620 to a memory device, a first request message for a recovery configuration associated with power recovery of a peripheral of the memory device. In some examples, the message component 625 may be configured as or otherwise support a means for receiving, from the memory device based at least in part on transmitting the first request message, a first response message including the recovery configuration associated with the power recovery of the peripheral of the memory device, the recovery configuration including parametric data associated with the peripheral of the memory device for storing at the host device 620.

In some examples, the configuration component 630 may be configured as or otherwise support a means for storing, at the host device 620, the recovery configuration including the parametric data associated with the peripheral of the memory device based at least in part on receiving the first response message.

In some examples, the message component 625 may be configured as or otherwise support a means for transmitting, to the memory device, a second request message for operating the peripheral of the memory device in a power mode, the second request message indicating timing information for switching the peripheral of the memory device to the power mode, and the second request message including a SSU request UPIU. In some examples, the message component 625 may be configured as or otherwise support a means for transmitting the first request message, or receiving the first response message, or a combination thereof, based at least in part on transmitting the second request message.

In some examples, the message component 625 may be configured as or otherwise support a means for receiving, from the memory device, second response message based at least in part on receiving the second request message, the second response message indicating that the peripheral of the memory device is operating in the power mode, and the second response message including an SSU response UPIU. In some examples, the message component 625 may be configured as or otherwise support a means for transmitting the first request message, or receiving the first response message, or a combination thereof, based at least in part on receiving the second response message.

In some examples, the message component 625 may be configured as or otherwise support a means for transmitting, to the memory device, second request message including the recovery configuration associated with power recovery of the peripheral of the memory device. In some examples, the message component 625 may be configured as or otherwise support a means for receiving, from the memory device, a second response message including an acknowledgment based at least in part on transmitting the second request message.

In some examples, the connection component 635 may be configured as or otherwise support a means for initializing a connection path between the peripheral of the memory device and the host device 620 based at least in part on transmitting the second request message, or receiving the second response message, or a combination thereof.

In some examples, the recovery configuration including the parametric data is associated with a physical layer of the peripheral of the memory device, or a physical layer of the peripheral of the host device 620, or a combination thereof.

In some examples, the message component 625 may be configured as or otherwise support a means for transmitting, from the host device 620 to a memory device, a first request message including a recovery configuration associated with a peripheral of the memory device for power recovery of the peripheral of the memory device, the recovery configuration including the parametric data associated with the peripheral of the memory device. In some examples, the message component 625 may be configured as or otherwise support a means for receiving, from the memory device, a first response message based at least in part on transmitting, to the memory device, the first request message. In some examples, the recovery configuration including the parametric data associated with the peripheral of the memory device is stored at the host device 620.

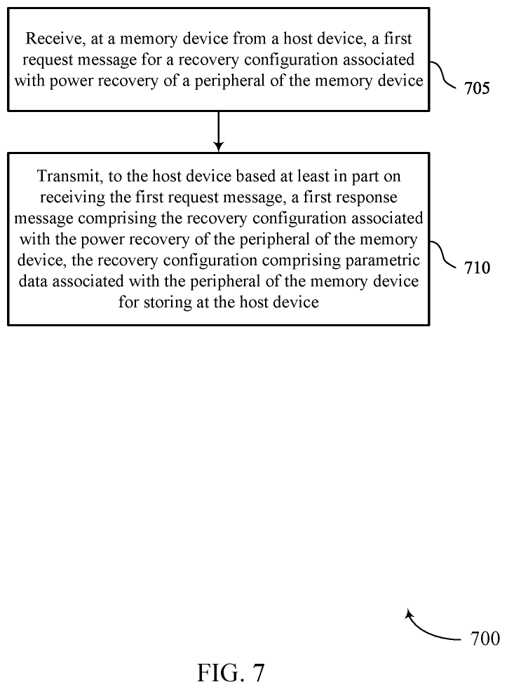

FIG. 7 shows a flowchart illustrating a method 700 that supports host assisted link start in accordance with examples as disclosed herein. The operations of method 700 may be implemented by a memory device or its components as described herein. For example, the operations of method 700 may be performed by a memory device as described with reference to FIGS. 1 through 5. In some examples, a memory device may execute a set of instructions to control the functional elements of the device to perform the described functions. Additionally, or alternatively, the memory device may perform aspects of the described functions using special-purpose hardware.

At 705, the method may include receiving, at a memory device from a host device, a first request message for a recovery configuration associated with power recovery of a peripheral of the memory device. The operations of 705 may be performed in accordance with examples as disclosed herein. In some examples, aspects of the operations of 705 may be performed by a message component 525 as described with reference to FIG. 5.

At 710, the method may include transmitting, to the host device based at least in part on receiving the first request message, a first response message including the recovery configuration associated with the power recovery of the peripheral of the memory device, the recovery configuration including parametric data associated with the peripheral of the memory device for storing at the host device. The operations of 710 may be performed in accordance with examples as disclosed herein. In some examples, aspects of the operations of 710 may be performed by a message component 525 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory device from a host device, a first request message for a recovery configuration associated with power recovery of a peripheral of the memory device and transmitting, to the host device based at least in part on receiving the first request message, a first response message including the recovery configuration associated with the power recovery of the peripheral of the memory device, the recovery configuration including parametric data associated with the peripheral of the memory device for storing at the host device.

Aspect 2: The method, apparatus, or non-transitory computer-readable medium of aspect 1, further including operations, features, circuitry, logic, means, or instructions, or any combination thereof for operating the peripheral of the memory device in a power mode of a set of power modes based at least in part on receiving the first request message, or transmitting the first response message, or a combination thereof.

Aspect 3: The method, apparatus, or non-transitory computer-readable medium of aspect 2, further including operations, features, circuitry, logic, means, or instructions, or any combination thereof for receiving, from the host device, a second request message for operating the peripheral of the memory device in a power mode, the second request message indicating timing information for switching the peripheral of the memory device to the power mode, and the second request message including a SSU request UPIU and where receiving the first request message, or transmitting the first response message, or a combination thereof, is based at least in part on receiving the second request message.

Aspect 4: The method, apparatus, or non-transitory computer-readable medium of aspect 3, further including operations, features, circuitry, logic, means, or instructions, or any combination thereof for processing one or more operations associated with the peripheral of the memory device based at least in part on receiving the second request message; operating the peripheral of the memory device in the power mode based at least in part on processing the one or more operations associated with the peripheral of the memory device; and where receiving the first request message, or transmitting the first response message, or a combination thereof, is based at least in part on operating the peripheral of the memory device in the power mode.

Aspect 5: The method, apparatus, or non-transitory computer-readable medium of aspect 4, further including operations, features, circuitry, logic, means, or instructions, or any combination thereof for transmitting, to the host device, a second response message based at least in part on receiving the second request message and processing the one or more operations associated with the peripheral of the memory device, the second response message indicating that the peripheral of the memory device is operating in the power mode, and the second response message including an SSU response UPIU and where receiving the first request message, or transmitting the first response message, or a combination thereof, is based at least in part on transmitting the second response message.

Aspect 6: The method, apparatus, or non-transitory computer-readable medium of any of aspects 3 through 5, further including operations, features, circuitry, logic, means, or instructions, or any combination thereof for enabling a timer based at least in part on the timing information and where operating the peripheral of the memory device in the power mode is based at least in part on an expiration of the timer.

Aspect 7: The method, apparatus, or non-transitory computer-readable medium of any of aspects 1 through 6, further including operations, features, circuitry, logic, means, or instructions, or any combination thereof for generating the recovery configuration including the parametric data associated with the peripheral of the memory device based at least in part on receiving the first request message and where transmitting the first response message is based at least in part on generating the recovery configuration including the parametric data associated with the peripheral of the memory device.

Aspect 8: The method, apparatus, or non-transitory computer-readable medium of any of aspects 1 through 7, further including operations, features, circuitry, logic, means, or instructions, or any combination thereof for receiving, from the host device, a second request message including the recovery configuration associated with power recovery of the peripheral of the memory device and operating the peripheral of the memory device in a first power mode by switching to the first power mode from a second power mode based at least in part on receiving the second request message.

Aspect 9: The method, apparatus, or non-transitory computer-readable medium of aspect 8, further including operations, features, circuitry, logic, means, or instructions, or any combination thereof for reconfiguring the peripheral of the memory device based at least in part on receiving the second request message including the recovery configuration including the parametric data associated with the peripheral of the memory device and switching to the first power mode from the second power mode.

Aspect 10: The method, apparatus, or non-transitory computer-readable medium of any of aspects 8 through 9, further including operations, features, circuitry, logic, means, or instructions, or any combination thereof for transmitting, to the host device, a second response message including an acknowledgment based at least in part on receiving the second request message and where operating the peripheral of the memory device in the first power mode by switching to the first power mode from the second power mode is based at least in part on transmitting the second response message.

Aspect 11: The method, apparatus, or non-transitory computer-readable medium of aspect 10, further including operations, features, circuitry, logic, means, or instructions, or any combination thereof for performing a boot operation for the power recovery of the peripheral of the memory device based at least in part on receiving the second request message, or transmitting the second response message, or a combination thereof and where the boot operation includes initializing a connection path between the peripheral of the memory device and the host device.

Aspect 12: The method, apparatus, or non-transitory computer-readable medium of aspect 11, further including operations, features, circuitry, logic, means, or instructions, or any combination thereof for receiving, from the host device, a first ping message over the connection path between the peripheral of the memory device and the host device and transmitting, to the host device, a second ping message over the connection path between the peripheral of the memory device and the host device and based at least in part on receiving the first ping message.

Aspect 13: The method, apparatus, or non-transitory computer-readable medium of any of aspects 1 through 12, where the recovery configuration including the parametric data is associated with a physical layer of the peripheral of the memory device, or a physical layer of the peripheral of the host device, or a combination thereof.

Aspect 14: The method, apparatus, or non-transitory computer-readable medium of any of aspects 1 through 13, where the peripheral of the memory device includes a peripheral memory associated with one or more I/O devices.

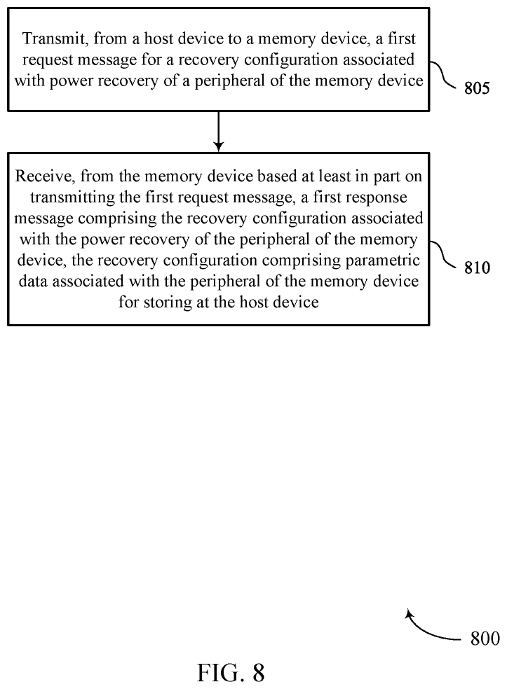

FIG. 8 shows a flowchart illustrating a method 800 that supports host assisted link start in accordance with examples as disclosed herein. The operations of method 800 may be implemented by a host device or its components as described herein. For example, the operations of method 800 may be performed by a host device as described with reference to FIGS. 1 through 4 and 6. In some examples, a host device may execute a set of instructions to control the functional elements of the device to perform the described functions. Additionally, or alternatively, the host device may perform aspects of the described functions using special-purpose hardware.

At 805, the method may include transmitting, from a host device to a memory device, a first request message for a recovery configuration associated with power recovery of a peripheral of the memory device. The operations of 805 may be performed in accordance with examples as disclosed herein. In some examples, aspects of the operations of 805 may be performed by a message component 625 as described with reference to FIG. 6.

At 810, the method may include receiving, from the memory device based at least in part on transmitting the first request message, a first response message including the recovery configuration associated with the power recovery of the peripheral of the memory device, the recovery configuration including parametric data associated with the peripheral of the memory device for storing at the host device. The operations of 810 may be performed in accordance with examples as disclosed herein. In some examples, aspects of the operations of 810 may be performed by a message component 625 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for transmitting, from a host device to a memory device, a first request message for a recovery configuration associated with power recovery of a peripheral of the memory device and receiving, from the memory device based at least in part on transmitting the first request message, a first response message including the recovery configuration associated with the power recovery of the peripheral of the memory device, the recovery configuration including parametric data associated with the peripheral of the memory device for storing at the host device.

Aspect 16: The method, apparatus, or non-transitory computer-readable medium of aspect 15, further including operations, features, circuitry, logic, means, or instructions, or any combination thereof for storing, at the host device, the recovery configuration including the parametric data associated with the peripheral of the memory device based at least in part on receiving the first response message.

Aspect 17: The method, apparatus, or non-transitory computer-readable medium of any of aspects 15 through 16, further including operations, features, circuitry, logic, means, or instructions, or any combination thereof for transmitting, to the memory device, a second request message for operating the peripheral of the memory device in a power mode, the second request message indicating timing information for switching the peripheral of the memory device to the power mode, and the second request message including a SSU request UPIU and where transmitting the first request message, or receiving the first response message, or a combination thereof, is based at least in part on transmitting the second request message.

Aspect 18: The method, apparatus, or non-transitory computer-readable medium of aspect 17, further including operations, features, circuitry, logic, means, or instructions, or any combination thereof for receiving, from the memory device, second response message based at least in part on receiving the second request message, the second response message indicating that the peripheral of the memory device is operating in the power mode, and the second response message including an SSU response UPIU and where transmitting the first request message, or receiving the first response message, or a combination thereof, is based at least in part on receiving the second response message.

Aspect 19: The method, apparatus, or non-transitory computer-readable medium of any of aspects 15 through 18, further including operations, features, circuitry, logic, means, or instructions, or any combination thereof for transmitting, to the memory device, second request message including the recovery configuration associated with power recovery of the peripheral of the memory device and receiving, from the memory device, a second response message including an acknowledgment based at least in part on transmitting the second request message.

Aspect 20: The method, apparatus, or non-transitory computer-readable medium of aspect 19, further including operations, features, circuitry, logic, means, or instructions, or any combination thereof for initializing a connection path between the peripheral of the memory device and the host device based at least in part on transmitting the second request message, or receiving the second response message, or a combination thereof.

Aspect 21: The method, apparatus, or non-transitory computer-readable medium of any of aspects 15 through 20, where the recovery configuration including the parametric data is associated with a physical layer of the peripheral of the memory device, or a physical layer of the peripheral of the host device, or a combination thereof.

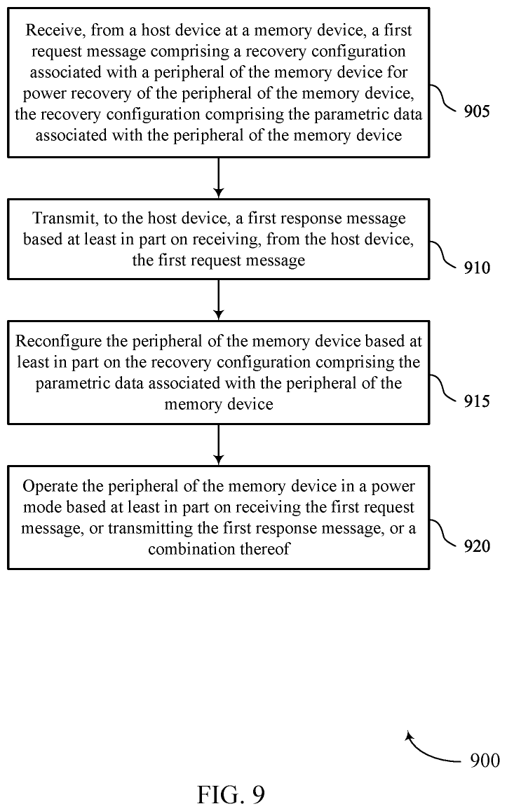

FIG. 9 shows a flowchart illustrating a method 900 that supports host assisted link start in accordance with examples as disclosed herein. The operations of method 900 may be implemented by a memory device or its components as described herein. For example, the operations of method 900 may be performed by a memory device as described with reference to FIGS. 1 through 5. In some examples, a memory device may execute a set of instructions to control the functional elements of the device to perform the described functions. Additionally, or alternatively, the memory device may perform aspects of the described functions using special-purpose hardware.

At 905, the method may include receiving, from a host device at a memory device, a first request message including a recovery configuration associated with a peripheral of the memory device for power recovery of the peripheral of the memory device, the recovery configuration including the parametric data associated with the peripheral of the memory device. The operations of 905 may be performed in accordance with examples as disclosed herein. In some examples, aspects of the operations of 905 may be performed by a message component 525 as described with reference to FIG. 5.

At 910, the method may include transmitting, to the host device, a first response message based at least in part on receiving, from the host device, the first request message. The operations of 910 may be performed in accordance with examples as disclosed herein. In some examples, aspects of the operations of 910 may be performed by a message component 525 as described with reference to FIG. 5.

At 915, the method may include reconfiguring the peripheral of the memory device based at least in part on the recovery configuration including the parametric data associated with the peripheral of the memory device. The operations of 915 may be performed in accordance with examples as disclosed herein. In some examples, aspects of the operations of 915 may be performed by a configuration component 530 as described with reference to FIG. 5.

At 920, the method may include operating the peripheral of the memory device in a power mode based at least in part on receiving the first request message, or transmitting the first response message, or a combination thereof. The operations of 920 may be performed in accordance with examples as disclosed herein. In some examples, aspects of the operations of 920 may be performed by a mode component 535 as described with reference to FIG. 5.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 22: A method, apparatus, or non-transitory computer-readable medium including operations, features, circuitry, logic, means, or instructions, or any combination thereof for receiving, from a host device at a memory device, a first request message including a recovery configuration associated with a peripheral of the memory device for power recovery of the peripheral of the memory device, the recovery configuration including the parametric data associated with the peripheral of the memory device; transmitting, to the host device, a first response message based at least in part on receiving, from the host device, the first request message; reconfiguring the peripheral of the memory device based at least in part on the recovery configuration including the parametric data associated with the peripheral of the memory device; and operating the peripheral of the memory device in a power mode based at least in part on receiving the first request message, or transmitting the first response message, or a combination thereof.

Aspect 23: The method, apparatus, or non-transitory computer-readable medium of aspect 22, where the recovery configuration including the parametric data associated with the peripheral of the memory device is stored at the host device.

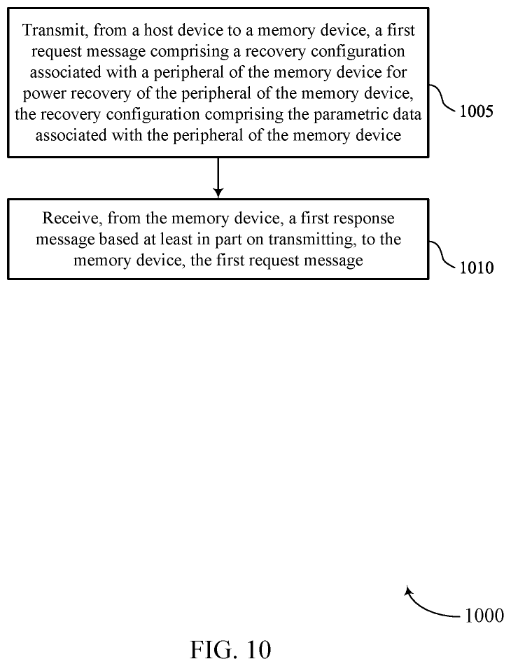

FIG. 10 shows a flowchart illustrating a method 1000 that supports host assisted link start in accordance with examples as disclosed herein. The operations of method 1000 may be implemented by a host device or its components as described herein. For example, the operations of method 1000 may be performed by a host device as described with reference to FIGS. 1 through 4 and 6. In some examples, a host device may execute a set of instructions to control the functional elements of the device to perform the described functions. Additionally, or alternatively, the host device may perform aspects of the described functions using special-purpose hardware.

At 1005, the method may include transmitting, from a host device to a memory device, a first request message including a recovery configuration associated with a peripheral of the memory device for power recovery of the peripheral of the memory device, the recovery configuration including the parametric data associated with the peripheral of the memory device. The operations of 1005 may be performed in accordance with examples as disclosed herein. In some examples, aspects of the operations of 1005 may be performed by a message component 625 as described with reference to FIG. 6.

At 1010, the method may include receiving, from the memory device, a first response message based at least in part on transmitting, to the memory device, the first request message. The operations of 1010 may be performed in accordance with examples as disclosed herein. In some examples, aspects of the operations of 1010 may be performed by a message component 625 as described with reference to FIG. 6.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 24: A method, apparatus, or non-transitory computer-readable medium including operations, features, circuitry, logic, means, or instructions, or any combination thereof for transmitting, from a host device to a memory device, a first request message including a recovery configuration associated with a peripheral of the memory device for power recovery of the peripheral of the memory device, the recovery configuration including the parametric data associated with the peripheral of the memory device and receiving, from the memory device, a first response message based at least in part on transmitting, to the memory device, the first request message.

Aspect 25: The method, apparatus, or non-transitory computer-readable medium of aspect 24, where the recovery configuration including the parametric data associated with the peripheral of the memory device is stored at the host device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “in response to,” “based on,” or “based at least in part on” may be used interchangeably. In some examples, if the terms “if,” “in response to,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device; and
a controller coupled with the memory device and configured to cause the apparatus to:
receive, from a host device, a first request message for a recovery configuration associated with power recovery of a peripheral of the memory device; and
transmit, to the host device based at least in part on the first request message, a first response message comprising the recovery configuration associated with the power recovery of the peripheral of the memory device, the recovery configuration comprising parametric data associated with the peripheral of the memory device to store at the host device.

2. The apparatus of claim 1, wherein the controller is further configured to cause the apparatus to:
operate the peripheral of the memory device in a power mode of a set of power modes based at least in part on the first request message, or the first response message, or a combination thereof.

3. The apparatus of claim 1, wherein the controller is further configured to cause the apparatus to:
generate the recovery configuration comprising the parametric data associated with the peripheral of the memory device based at least in part on the first request message.

4. The apparatus of claim 2, wherein the controller is further configured to cause the apparatus to:
receive, from the host device, a second request message to operate the peripheral of the memory device in a power mode, the second request message indicating timing information to switch the peripheral of the memory device to the power mode, and the second request message comprising a Start-Stop-Unit (SSU) request Universal Flash Storage (UFS) Protocol Information Unit (UPIU),
wherein the controller is configured to cause the apparatus to receive the first request message, or transmit the first response message, or a combination thereof, based at least in part on the second request message.

5. The apparatus of claim 4, wherein the controller is further configured to cause the apparatus to:
process one or more operations associated with the peripheral of the memory device based at least in part on the second request message; and
operate the peripheral of the memory device in the power mode based at least in part on the one or more operations associated with the peripheral of the memory device.

6. The apparatus of claim 5, wherein the controller is further configured to cause the apparatus to:
transmit, to the host device, a second response message based at least in part on the second request message and the one or more operations associated with the peripheral of the memory device, the second response message indicating that the peripheral of the memory device is operating in the power mode, and the second response message comprising an SSU response UPIU,
wherein the controller is configured to cause the apparatus to receive the first request message, or transmit the first response message, or a combination thereof, based at least in part on the second response message.

7. The apparatus of claim 4, wherein the controller is further configured to cause the apparatus to:
enable a timer based at least in part on the timing information,
wherein the controller is configured to cause the apparatus to operate the peripheral of the memory device in the power mode based at least in part on an expiration of the timer.

8. The apparatus of claim 1, wherein the controller is further configured to cause the apparatus to:
receive, from the host device, a second request message comprising the recovery configuration associated with the power recovery of the peripheral of the memory device; and
operate the peripheral of the memory device in a first power mode by switching to the first power mode from a second power mode based at least in part on the second request message.

9. The apparatus of claim 8, wherein the controller is further configured to cause the apparatus to:
reconfigure the peripheral of the memory device based at least in part on the second request message comprising the recovery configuration comprising the parametric data associated with the peripheral of the memory device and switching to the first power mode from the second power mode.

10. The apparatus of claim 8, wherein the controller is further configured to cause the apparatus to:
transmit, to the host device, a second response message comprising an acknowledgment based at least in part on the second request message,
wherein the controller is configured to cause the apparatus to operate the peripheral of the memory device in the first power mode by switching to the first power mode from the second power mode based at least in part on the second response message.

11. The apparatus of claim 10, wherein the controller is further configured to cause the apparatus to:
perform a boot operation for the power recovery of the peripheral of the memory device based at least in part on the second request message, or the second response message, or a combination thereof; and
initialize a connection path between the peripheral of the memory device and the host device based at least in part on the boot operation.

12. The apparatus of claim 11, wherein the controller is further configured to cause the apparatus to:
receive, from the host device, a first ping message over the connection path between the peripheral of the memory device and the host device; and
transmit, to the host device, a second ping message over the connection path between the peripheral of the memory device and the host device and based at least in part on the first ping message.

13. The apparatus of claim 1, wherein the recovery configuration comprising the parametric data is associated with a physical layer of the peripheral of the memory device, or a physical layer of the peripheral of the host device, or a combination thereof.

14. The apparatus of claim 1, wherein the peripheral of the memory device comprises a peripheral memory associated with one or more input/output (I/O) devices.

15. An apparatus, comprising:
a controller configured to couple with a memory device, wherein the controller is configured to cause the apparatus to:
transmit, to the memory device, a first request message for a recovery configuration associated with power recovery of a peripheral of the memory device; and
receive, from the memory device based at least in part on the first request message, a first response message comprising the recovery configuration associated with the power recovery of the peripheral of the memory device, the recovery configuration comprising parametric data associated with the peripheral of the memory device to store at the apparatus.

16. The apparatus of claim 15, wherein the controller is further configured to cause the apparatus to:
store the recovery configuration comprising the parametric data associated with the peripheral of the memory device based at least in part on the first response message.

17. The apparatus of claim 15, wherein the controller is further configured to cause the apparatus to:
transmit, to the memory device, a second request message to operate the peripheral of the memory device in a power mode, the second request message indicating timing information to switch the peripheral of the memory device to the power mode, and the second request message comprising a Start-Stop-Unit (SSU) request Universal Flash Storage (UFS) Protocol Information Unit (UPIU),
wherein the controller is configured to cause the apparatus to transmit the first request message, or receive the first response message, or a combination thereof, based at least in part on the second request message.

18. The apparatus of claim 17, wherein the controller is further configured to cause the apparatus to:
receive, from the memory device, second response message based at least in part on the second request message, the second response message indicating that the peripheral of the memory device is operating in the power mode, and the second response message comprising an SSU response UPIU,
wherein the controller is configured to cause the apparatus to transmit the first request message, or receive the first response message, or a combination thereof, based at least in part on the second response message.

19. The apparatus of claim 15, wherein the controller is further configured to cause the apparatus to:
transmit, to the memory device, second request message comprising the recovery configuration associated with the power recovery of the peripheral of the memory device; and
receive, from the memory device, a second response message comprising an acknowledgment based at least in part on the second request message.

20. An apparatus, comprising:
a memory device; and
a controller coupled with the memory device and configured to cause the apparatus to:
receive, from a host device, a first request message comprising a recovery configuration associated with power recovery of a peripheral of the memory device, the recovery configuration comprising parametric data associated with the peripheral of the memory device;
transmit, to the host device, a first response message based at least in part on the first request message;
reconfigure the peripheral of the memory device based at least in part on the recovery configuration comprising the parametric data associated with the peripheral of the memory device; and
operate the peripheral of the memory device in a power mode based at least in part on the first request message, or the first response message, or a combination thereof.
